(19) United States
(12) Patent Application Publication
(10) Pub. No.: US 2011/0215694 A1
(43) Pub. Date: Sep. 8, 2011

(54) HANDLE HOLDER AND DOMESTIC APPLIANCE

(75) Inventors: Jürgen Fink, Gerstetten (DE); Andrea Fronmüller, Gerstetten (DE); Christian Wlczek, Munchen (DE)

(73) Assignee: BSH BOSCH UND SIEMENS HAUSGERÃ¤TE GMBH, Munich (DE)

(21) Appl. No.: 13/128,641

(22) PCT Filed: Dec. 10, 2008
(86) PCT No.: PCT/EP08/67230

§ 371 Date: May 11, 2011

(30) Foreign Application Priority Data
Dec. 5, 2008 (DE) 10 2008 044 385.9

(51) Int. Cl. F25D 23/02; A47B 96/00; A47B 95/02; E05B 3/00; F16B 9/00

(52) U.S. Cl. 312/405; 312/326; 403/188

(57) ABSTRACT

A handle holder for fastening a door handle on a door leaf of a domestic appliance includes a first component, which has a guiding and fastening device arranged in an interior of the first component. The guiding and fastening device accommodates an elongated fastener and enables introduction of the fastener through a side surface of the first component for fastening the handle holder on the door leaf. The fastener encloses an acute intermediate angle with a fastening side in confronting relationship to a side assigned to the device for securing the door handle. The handle holder has a second component, which has a side with an integrated device for securing the door handle. The second component has a first cavity for insertion of the first component and is configured to enable the fastener to be introduced through a side surface of the second component into the guiding and fastening device.

The invention relates to a handle holder in particular for the door leaf of a refrigeration appliance and a domestic appliance, in particular a domestic refrigeration appliance.

The document U.S. Pat. No. 7,263,744 B2 discloses a handle assembly for a refrigerator. The handle assembly comprises a pair of handle holders, each of which is formed with a recess therein. The handle holders are mounted on the front surface of a door leaf by means of screws which pass through rear parts of the handle holders by way of the recesses. The handle holders have spacer pieces. A handle body which is screwed to the handle holders is positioned between the handle holders and a handle cover is elastically mounted on the front ends of the handle holders and the handle body.

The object of the invention is to specify an alternate handle holder, in particular for the door leaf of a refrigeration appliance.

The object of the invention is achieved by a handle holder for fastening a door handle on a door leaf of a domestic appliance, comprising

a first component having a guiding and fastening device arranged in the interior of the first component which is intended to accommodate an elongated fastening means, by means of which the handle holder can be fastened on the door leaf, and which is configured such that the fastening means can be introduced through a side surface of the first component for fastening the handle holder on the door leaf, and

a second component, which has a side with an integrally arranged device for securing the door handle and has a first cavity in which the first component is inserted, whereby the second component is configured such that the fastening means can be introduced through a side surface of the second component into the guiding and fastening device, and the first component is configured such that the fastening means encloses an acute intermediate angle with a fastening side located opposite the side assigned to the device for securing the door handle.

A further aspect of the invention relates to a domestic appliance, in particular a domestic refrigeration appliance, having a carcass, a door leaf with an outer surface mounted on the carcass, a door handle, a handle holder according to the invention holding the door handle, and an elongated fastening means, which in particular is a screw, by means of which the handle holder is fastened on the outer surface of the door leaf and which is accommodated by the guiding and fastening device of the handle holder according to the invention such that it encloses an acute intermediate angle with the outer surface of the door leaf.

According to one variant, the domestic appliance according to the invention has a further handle holder fastened on the outer surface of the door leaf, whereby the door handle is fixed between the handle holder according to the invention and the further handle holder.

The handle holder according to the invention is accordingly provided for fastening a door handle on a door leaf of a domestic appliance, which in particular is a domestic refrigeration appliance. Examples of domestic refrigeration appliances are freezers, refrigerators or combined freezer refrigerators.

The handle holder according to the invention is designed in two parts and comprises the two components. The first component, which is inserted in the cavity of the second component (first cavity), is preferably designed in one piece and has in its interior the guiding and fastening device. The guiding and fastening device is intended to accommodate the elongated fastening means by means of which the handle holder according to the invention can be fastened on the door leaf of the domestic appliance. A screw is preferably used as the elongated fastening means, but a fastening means of another design, such as for example a rivet, can also be used.

Furthermore, the guiding and fastening device is arranged in such a manner on one of the side surfaces of the first component and is configured such that the fastening means encloses the acute intermediate angle with the fastening side.

It is thus possible to introduce the fastening means laterally with respect to the handle holder according to the invention into the guiding and fastening device for fastening on the door leaf.

The device for securing the door handle, by means of which where applicable the door handle can be fastened on the domestic appliance or the door leaf thereof, is typically molded onto the second component, in the interior of which the first component is inserted in order to obtain the handle holder according to the invention.

The screw, generally the elongated fastening means, can thus be turned at a sloping angle directly into a backing part, embedded in foam where applicable, of the door leaf. It is also possible to improve the assembly process.

According to a variant of the inventive handle holder, the guiding and fastening device thereof has a tubular or cylindrical guide facility arranged in the interior of the first component, the longitudinal axis of which encloses the acute intermediate angle with the fastening side and which is provided for accommodating the fastening means such that the fastening means encloses the acute intermediate angle with the fastening side. With regard to the fastening means, this is for example a screw or a rivet, or an otherwise elongated fastening means. As a general rule such a fastening means comprises a tubular or cylindrical section which is held or guided by the tubular or cylindrical guide facility of the guiding and fastening device in such a manner that the fastening means encloses the acute intermediate angle.

According to a form of embodiment of the inventive handle holder, the first component of said handle holder has lateral walls delimiting a second cavity and the guiding and fastening device is in particular formed integrally on one of the lateral walls and is arranged inside the second cavity as the interior of the first component. According to this variant, the first component comprises the lateral walls, which are for example an upper, a lower and two side walls. The first component preferably has neither a rear wall nor a front wall, in order for example to produce the first component relatively simply, as is intended according to a preferred variant, in one piece using an injection molding or die casting process, in particular using a zinc die casting process or a plastic injection molding process. The second component is also preferably produced in one piece using an injection molding or die casting process, in particular using a zinc die casting process or a plastic injection molding process.

According to a further variant of the handle holder according to the invention, the wall on which the guiding and fastening device is integrally formed has a first opening assigned to the guiding and fastening device, which is intended for the introduction of the fastening means. The first opening can in particular be chosen in such a manner that the fastening means can be introduced in a relatively simple manner into the guiding and fastening device and where applicable into the tubular or cylindrical guide facility.

The guiding and fastening device can have a recess projecting into the cavity and integrally formed on the wall assigned to the guiding and fastening device, which recess is intended for the introduction of the fastening means and to which the tubular or cylindrical guide facility attaches. The recess has where applicable the form of an indentation in the wall assigned to the guiding and fastening device and creates prerequisites for introducing the fastening means in a relatively simple manner into the tubular or cylindrical guide facility.

According to a variant of the handle holder according to the invention, the side surface of the second component, through which the fastening means can be introduced into the guiding and fastening device, has a second opening aligned with the first opening. It is thereby made possible to arrange the fastening means in the guiding and fastening device of the first component through the second component.

In order to produce the handle holder according to the invention the first component can be pressed into the cavity of the second component. The two components can preferably be configured such that the first component is fixed in the cavity of the second component by means of an interference fit. Alternatively or additionally, the first component can also be adhesively bonded in the second component.

According to an embodiment of the handle holder according to the invention, the second component thereof has lateral walls delimiting the first cavity and a front wall opposite the fastening side. In order where applicable to create an improved hold on the door handle, the front wall can preferably be a wall separating the device for securing the door handle from the first cavity. The lateral walls and/or the front wall can preferably be formed integrally on the second component.

The device for securing the door handle can preferably be pot-shaped in design, such that the door handle can be inserted therein. Part of the pot-shaped configuration is in particular the front wall of the second component which where applicable separates the device for securing the door handle from the first cavity. With regard to this variant of the handle holder according to the invention, it is closed at the front and the door handle, which for example is designed as a handle bar, is completely surrounded radially by the pot-shaped device for securing the door handle. The guiding and fastening device according to the invention (depending on fastening means: sloping screw guidance) can however form an undercut in the cavity of the first component, which for example is configured as an insert, which undercut requires an access from the front in order to enable it to be appropriately designed and demolded in respect of tooling with regard to one-piece implementation. According to this variant of the handle holder according to the invention it would thus not be possible to demold this undercut from the front end if the guiding and fastening device were formed in one piece in the cavity of the second component comprising the device for securing the door handle. Depending on the form of embodiment, the first component can however have an opening to the front or even be completely open in order to enable said undercut to be demolded relatively simply.

On account of its two-piece implementation the handle holder according to the invention thus makes it possible to implement said handle holder closed from the front.

An exemplary embodiment of the invention is illustrated by way of example in the attached schematic drawings, in which:

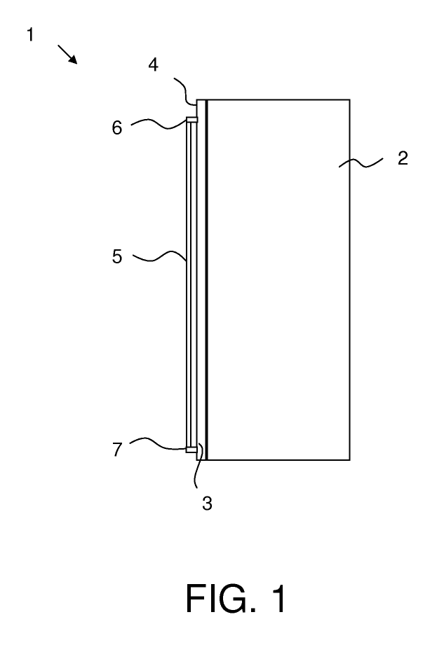

FIG. 1 shows a domestic refrigeration appliance having a handle holder for fastening a door handle of the domestic refrigeration appliance,

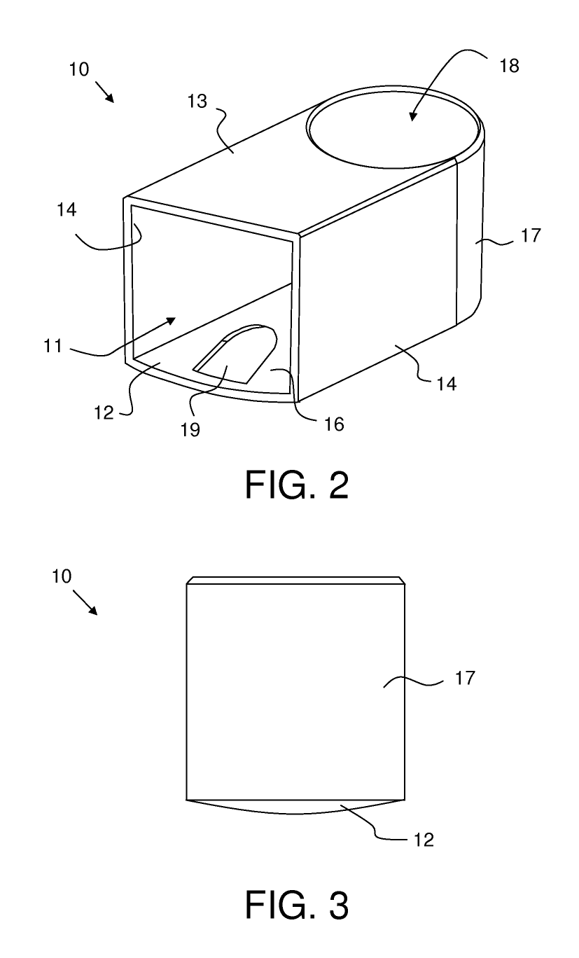

FIG. 2 shows a perspective view of a base body of the handle holder,

FIG. 3 shows a front view of the base body,

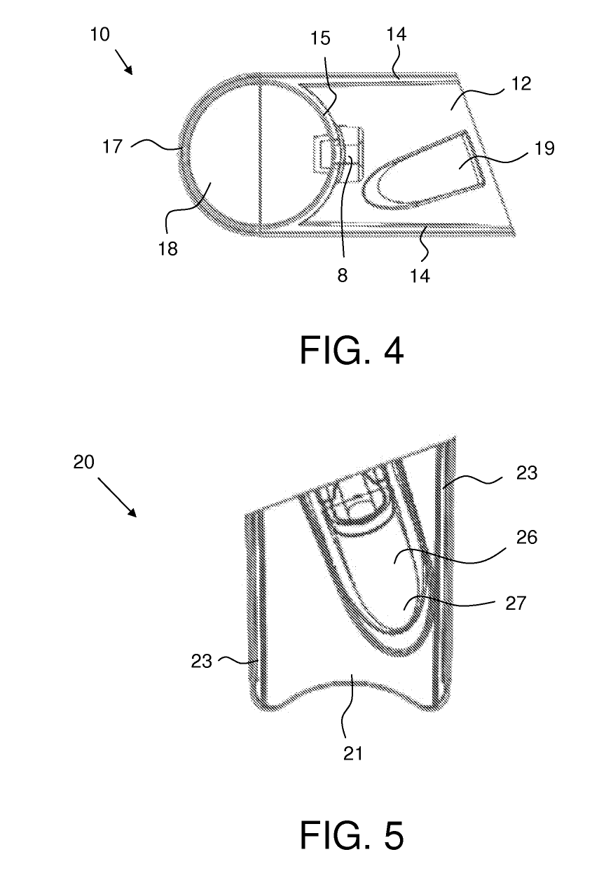

FIG. 4 shows a sectional view of the base body,

FIG. 5 shows a top view of an insert of the handle holder,

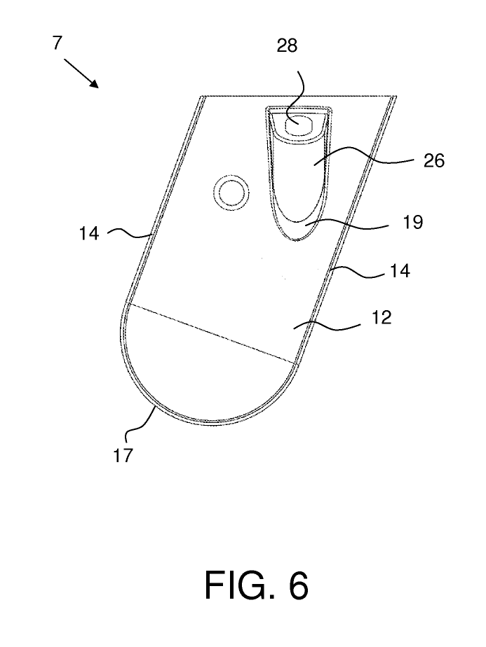

FIG. 6 shows a top view of the handle holder,

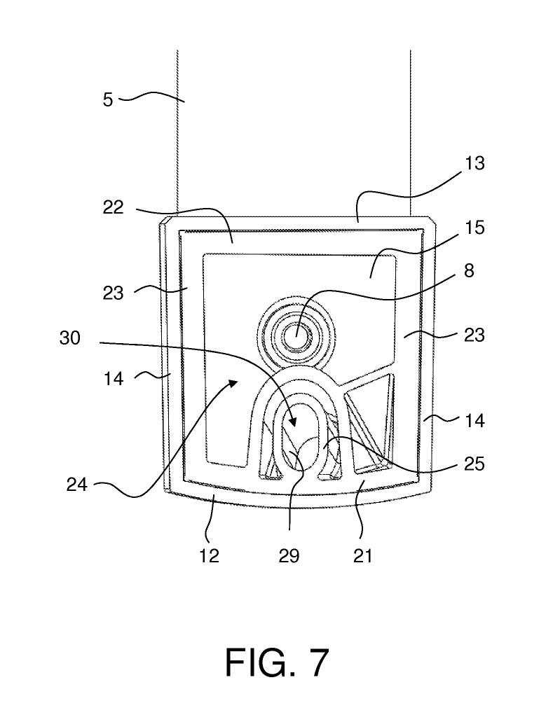

FIG. 7 shows a rear view of the handle holder and

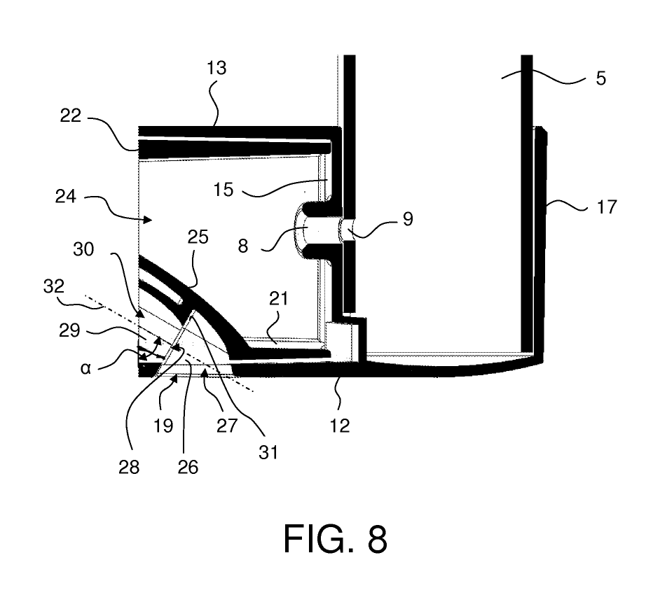

FIG. 8 shows a sectional view of the handle holder with a part of the door handle.

FIG. 1 shows a side view of a domestic refrigeration appliance 1 as an example of a refrigeration appliance, generally as an example of a domestic appliance. The domestic refrigeration appliance 1 has in a generally known manner a housing 2 which delimits a thermally insulated interior chamber or refrigerating compartment, not illustrated in more detail. On the housing 2 is mounted for example by means of hinges (not illustrated) a thermally insulating door leaf 3 for closing the refrigerating compartment, which in the closed state closes the refrigerating compartment and in the opened state gives access to the refrigerating compartment such that for example goods to be chilled can be placed therein or chilled goods can be removed therefrom. The domestic refrigeration appliance 1 furthermore has a refrigeration circuit, not illustrated in more detail but known in principle to the person skilled in the art, which for example comprises an evaporator, a condenser and a compressor.

A door handle 5 oriented in the vertical direction is fastened on the door leaf 3 and in particular on the outer skin 4 of the door leaf 3 by means of an upper handle holder 6 and a lower handle holder 7. In the case of the present exemplary embodiment, the door handle 5 has the form of a tube manufactured for example from metal.

The lower handle holder 7 is constructed in two parts and comprises a one-part base body 10 and a one-part insert 20. FIG. 2 shows a perspective view, FIG. 3 shows a front view and FIG. 4 shows a sectional view of the base body 10 and FIG. 5 shows a top view of the insert 20.

In the case of the present exemplary embodiment, the two handle holders 6, 7 and in particular the lower handle holder 7 were produced using a zinc die casting process. It is however also possible to use other die casting processes, such as for example a plastic injection molding process, or other materials. It is also possible to produce the handle holders 6, 7 by means of milling.

In the case of the present exemplary embodiment, the two handle holders 6, 7 are screwed to the outer skin 4 of the door leaf 3 and the door handle 5 is fixed between the two handle holders 6, 7.

In the case of the present exemplary embodiment, the lower handle holder 7 comprises the one-part base body 10, produced for example by means of a die casting process, which has a lower wall 12, an upper wall 13, two lateral walls 14 and a front wall 15, which delimit a cavity 11. On its rear facing side in the mounted state of the door leaf 3 the base body 10 is open, such that the cavity 11 is accessible through an opening 16.

In the case of the present exemplary embodiment, the lower wall 12 is extended over the front wall 15 delimiting the cavity 11 and comprises a further wall 17, integrally formed on the lower wall 12, which together with the front wall 15 delimiting the cavity 11 forms a for example pot-shaped holding fixture 18, in which one end of the door handle 5 of the domestic refrigeration appliance 1 is inserted.

In the case of the present exemplary embodiment, the front wall 15 delimiting the cavity 11 includes an opening 8 and the door handle 5 includes an opening 9 corresponding to the opening 8, by means of which the door handle 5, when inserted in the holding fixture 18, can be screwed together with the base body 10 for example by using a screw (not illustrated).

In the case of the present exemplary embodiment, the lower wall 12 has an opening 19 in the region of the cavity 11, through which a screw, not illustrated in more detail, for fastening the lower handle holder 7 on the door leaf 3 can be passed during assembly of the domestic refrigeration appliance 1.

As already described above, the lower handle holder 7 comprises the insert 20 which is inserted into the cavity 11 of the base body 10. The lower handle holder 7, in other words the base body 10 with insert 20 inserted in its cavity 11, is shown as a top view in FIG. 6, as a rear view in FIG. 7 and in a sectional view in FIG. 8.

The insert 20 is for example produced in one piece in an injection molding process and in the case of the present exemplary embodiment comprises a lower wall 21, an upper wall 22 and two lateral walls 23, which delimit a cavity 24. The insert 20 has walls neither at the front nor at the rear, which means that the cavity 24 is accessible both from the front and also from the rear. The lower wall 21 and the upper wall 22 have a concave design in their front regions, such that they suitably fit precisely against the front wall 15 of the base body 10 delimiting the cavity 11 of the base body 10. Furthermore, the walls 12-14 of the base body 10 and the walls 21-23 of the insert 20 are configured such that the insert 20, when inserted into the cavity 11 of the base body 10, is fixed by means of an interference fit. In the case of the present exemplary embodiment, provision can alternatively or additionally be made such that the insert 20 is adhesively bonded with the base body 10 in order for example to provide better protection against slipping out.

In order to screw the lower handle holder 7 to the door leaf 3, the insert 20 has a screw guide 25 or screw receptacle. The screw guide 25 of the lower handle holder 7 or of the insert 20 is integrally formed on the lower wall 21 of the insert 20 and projects into the cavity 24 thereof.

In the case of the present exemplary embodiment, the screw guide 25 has a recess 26 projecting into the lower wall 21 of the insert 20 into the interior of the cavity 24 thereof, which recess 26 is accessible by way of an opening 27 in the lower wall 21 of the insert 20. The opening 27 in the lower wall 21 of the insert 20 is aligned with the opening 19 in the lower wall 12 of the base body 10 when the insert 20 is inserted in the base body 10, such that the recess 26 is accessible by way of the openings 19, 27.

The recess 26 includes a further opening 28, on which a tubular or cylindrical partial guide 29 of the screw guide 25 is integrally formed inside the cavity 24. The partial guide 29 ends at the rear part of the insert 20 facing the door leaf 3 and has a further opening 30 in this region. If the lower handle holder 7 is screwed to the outer skin 4 of the door leaf 3 by means of a screw passing inside the partial guide 29 and not illustrated in more detail, then where applicable an edge of the partial guide 29 delimiting the opening 30 bears against the outer skin 4 of the door leaf 3.

The screw guide 25 is moreover configured such that the partial guide 29 forms a step 31 in the region of the opening 28 facing the recess 26, against which step 31 presses the screw head of the screw which is used to screw the lower handle holder 7 to the door leaf 3 in order to press the lower handle holder 7 and fasten it against the outer skin 4 of the door leaf 3.

The screw guide 25 or the screw are furthermore configured such that when the screw head presses against the step 31 of the partial guide 29, the part having the thread of the screw projects from the cavity 24 and can thus be screwed to a mating thread in the outer skin 4 not illustrated in more detail in the figures.

The screw guide 25 is moreover configured such that the longitudinal axis 32 of the cylindrical partial guide 29 encloses an acute angle α with the surface of the outer skin 4 of the door leaf 3, which for example lies in the range between 30° and 45°. It is thereby possible when assembling the domestic refrigeration appliance 1 to bring the lower handle holder 7 close to the outer skin 4 of the door leaf 3 and subsequently or previously to introduce the screw in sloping fashion in particular from below into the screw guide 25 and in particular into the partial guide 29 in order to screw the lower handle holder 7 to the door leaf 3.

In the exemplary embodiment described the screw guide 25 is formed on the lower wall 21 of the insert 21. This is not absolutely necessary. It is also possible for the screw guide 25 to be formed onto one of the lateral walls 23 or the upper wall 22 of the insert 20, as long as it configured such that the screw or its longitudinal axis encloses an acute angle with the surface of the door leaf 3. The opening 19 in the base body 10 is then arranged in the corresponding wall.

In addition or alternatively, the upper handle holder 6 can also have a sloping screw guide 25. It is also not necessary for the door handle 5 to be vertically oriented. In particular, a horizontal orientation of the door handle 5 is possible.

The use of the handle holder 7 is also not restricted to the domestic refrigerator 1. In particular, other (domestic) refrigeration appliances, such as for example freezers or combined freezer refrigerators also come into consideration.

1-13. (canceled)

14. A handle holder for fastening a door handle on a door leaf of a domestic appliance, said handle comprising:
a first component having an interior and including a guiding and fastening device arranged in the interior and configured to accommodate an elongated fastener and to enable the fastener to be introduced through a side surface of the first component for fastening the handle holder on the door leaf, said fastener enclosing an acute intermediate angle with a fastening side in confronting relationship to a side assigned to the device for securing the door handle; and
a second component having a side with an integrally arranged device for securing the door handle and defining a first cavity for insertion of the first component, said second component being configured such that the fastener is able extend through a side surface of the second component into the guiding and fastening device.

15. The handle holder of claim 14, wherein the guiding and fastening device has a tubular or cylindrical guide facility arranged in the interior of the first component and defining a longitudinal axis which encloses the acute intermediate angle with the fastening side and is provided for accommodating the fastener such that the fastener encloses the acute intermediate angle with the fastening side.

16. The handle holder of claim 14, wherein the first component has lateral walls delimiting a second cavity, said guiding and fastening device being formed integrally on one of the lateral walls and arranged inside the second cavity.

17. The handle holder of claim 16, wherein the guiding and fastening device and the one of the lateral walls are made from one material.

18. The handle holder of claim 16, wherein the one of the lateral walls has a first opening assigned to the guiding and fastening device for introduction of the fastener.

19. The handle holder of claim 16, wherein the guiding and fastening device has a tubular or cylindrical guide facility arranged in the interior of the first component, and a recess projecting into the second cavity and formed integrally on the one of the lateral walls assigned to the guiding and fastening device, said recess being intended for introduction of the fastener and attachment of the tubular or cylindrical guide facility.

20. The handle holder of claim 16, wherein the one of the lateral walls and the recess are made from one material,

21. The handle holder of claim 18, wherein the side surface of the second component, through which the fastener can be introduced into the guiding and fastening device, has a second opening aligned with the first opening.

22. The handle holder of claim 14, wherein the second component has lateral walls delimiting the first cavity and a front wall opposite the fastening side for separating the device for securing the door handle from the first cavity.

23. The handle holder of claim 14, wherein the device for securing the door handle has a pot-shaped configuration for allowing the door handle to be inserted therein.

24. The handle holder of claim 14, wherein at least one of the first and second components is produced in one piece through a process selected from the group consisting of injection molding and die casting process.

25. The handle holder of claim 24, wherein the injection molding process is a plastic injection molding process.

26. The handle holder of claim 24, wherein the die casting process is a zinc die casting process.

27. The handle holder of claim 14, wherein the fastener is designed as a screw.

28. The handle holder of claim 14, wherein the first component is fixed in the first cavity of the second component through an interference fit and/or through adhesive bond.

29. A domestic appliance, comprising:
a carcass;
a door leaf with an outer surface mounted on the carcass;
a door handle;
a first handle holder for holding the door handle, said first handle holder including
a first component having an interior and including a guiding and fastening device arranged in the interior and configured to accommodate an elongated fastener and to enable the fastener to be introduced through a side surface of the first component for fastening the first handle holder on the door leaf, said fastener enclosing an acute intermediate angle with a fastening side in confronting relationship to a side assigned to the device for securing the door handle, and
a second component having a side with an integrally arranged device for securing the door handle and defining a first cavity for insertion of the first component, said second component being configured such that the fastener is able extend through a side surface of the second component into the guiding and fastening device; and
an elongated fastener securing the first handle holder on the outer surface of the door leaf and accommodated by the guiding and fastening device of the first handle holder such as to enclose an acute intermediate angle with the outer surface of the door leaf.

30. The domestic appliance of claim 29, constructed as a domestic refrigeration appliance.

31. The domestic appliance of claim 29, wherein the fastener is a screw.

32. The domestic appliance of claim 29, further comprising a second handle holder fastened on the outer surface of the door leaf, said the door handle being fixed between the first and second handle holders.
